(19) United States
(12) Patent Application Publication
(10) Pub. No.: US 2024/0428959 A1
(43) Pub. Date: Dec. 26, 2024

(54) NUCLEAR REACTOR FUEL ASSEMBLY SPACER GRID

(71) Applicants: PUBLICHNOE AKTSIONERNOE OBSHCHESTVO "NOVOSIBIRSKY ZAVOD KHIMKONTSENTRATOV" (PAO NZHK), g. Novosibirsk (RU); CHASTNOE UCHREZHDENIE ¿¿ OBESPECHENIYU NAUCHNOGO RAZVITIYA ATOMNOJ OTRASLI "NAUKA I INNOVACII", Moscow (RU)

(72) Inventor: Alexander Vladimirovich CHINNOV, g. Novosibirsk (RU)

(21) Appl. No.: 18/687,690

(22) PCT Filed: Aug. 31, 2021
(86) PCT No.: PCT/RU2021/000374

§ 371 Date: Feb. 28, 2024

(51) Int. Cl. G21C 3/33

(52) U.S. Cl. CPC G21C 3/33

(57) ABSTRACT

A spacer grid of a nuclear reactor fuel assembly. The spacer grid comprises a hexagonal rim having a field of hexagonal cells fixed therein. The field of hexagonal cells being made from a single sheet having a first surface and a second surface. The first surface and the second surface each comprise a plurality of bends and cuts that form radius elements at the ends of each cell. A diameter of a circle inscribed in each cell between at least three points of the radius elements closest to the center of the cell is calculated by the formula: D=d*k. D is the diameter of the circle inscribed, d is a diameter of a fuel element placed in the field of hexagonal cells, and k is a coefficient of springing of a bent radius element.

### TECHNICAL FIELD OF THE INVENTION

The invention relates to nuclear energy, and in particular to elements of fuel assemblies (FAs) of VVER-type nuclear reactors.

### PRIOR ART

In the safety issues of pressurized water reactors, special attention is paid to the rector core and, in particular, to one of its components, the fuel assembly (FA), which, as a rule, is equipped with spacer grids. The design features of these grids determine not only the operability of the fuel assembly, but also its critical heat flux margin or the margin in terms of critical heat flux (CHF) and critical power.

The presence of mixing elements on the grids causes mixing of the coolant between the cells and turbulization of the flow within the individual cells. This leads to equalization of the coolant temperature along the cross-section of the fuel channel, and, consequently, to an increase in the critical heat flux margin or critical power margin (see, N.I. Perepelitsa “Space Grids with Local Swirlers for PWR Fuel Assemblies.” Nuclear Engineering Abroad, 2006, No.1, p.3).

A known spacer grid for a nuclear reactor fuel assembly has a hexagonal rim with polyhedral cells placed inside it and joined together and to the rim, equipped with internal protrusions (see B.A. Dementiev Nuclear Power Reactors, 11th edition, M.Energoatomizdat 1990, p.44).

A known spacer grid for a nuclear reactor fuel assembly has cells joined together and to the rim, made of strip and provided with internal projections and notches (see patent RU No. 2127001 dated Mar. 27, 1997, published February 27, 1999, IPC 6G21C3/34), in which each pair of adjacent faces of the cells is connected to each other by welded points, which does not exclude lack of penetration of the cells and, as a consequence, a decrease in the reliability of operation in a nuclear reactor, which is one of the disadvantages of this design.

The closest in technical essence and achieved result to the claimed design of the device is a mixing distancing lattice of a nuclear reactor fuel assembly, comprising a hexagonal rim with a field of hexagonal cells fixed therein, provided with internal protrusions in each cell, made of a single sheet, so that the folded cells have bends and cuts for the cells in one row of cells arranged on one end face of the distancing lattice, and bends and cuts for the cells of the parallel row are placed on the other end face of the distancing lattice, wherein the cuts for cells are designed, so that deflectors are formed along the cell ends, bent at an angle to the cell axis in opposite directions (see patent RU No. 2632572, published on 06.07.2017, Bull. No. 28)—prototype.

The disadvantages of the analogs and the prototype are the insufficient level of mixing of the coolant flow during operation in a nuclear reactor and complexity of the design caused by the necessity of internal protrusions in the cells for reliable retention of the fuel elements.

### DISCLOSURE OF THE INVENTION

The technical problem of the invention is to improve the operational characteristics of the spacer grid, namely the function of mixing the coolant flow, with simultaneous reliable placement of the fuel elements in the grid cells, excluding their displacement, with the possibility of achieving the technical result by means of a single design solution. This will simplify the design, ensure manufacturability and reduce the cost of the product.

The stated technical problem is solved by a spacer grid of a nuclear reactor fuel assembly, comprising a hexagonal rim with a field of hexagonal cells fixed therein, made of a single sheet, so that the folded cells have bends and cuts for the cells in one row of cells arranged on one end face of the spacer grid, and bends and cuts for the cells of the parallel row are placed on the other end face of the spacer grid, these cuts for the cells are designed to form radius elements at the ends of the cell, bent in opposite directions and forming screw deflectors at the ends of the cell, according to the invention, the diameter of the circle inscribed between the three points of the radius elements closest to the center of the cell is calculated by the formula:

D=d·k, where

D is the diameter of the circle inscribed between the three points of the radius elements closest to the center of the cell, mm;

d is the diameter of the fuel element, mm;

k is a coefficient taking into account the springing of the bent radius element to ensure tension in the “cell-fuel element” connection.

The cell design without internal protrusions that partially screen the coolant flow, and with screw deflectors at the ends of the cell, formed when making cuts under the cells and bending the radius elements obtained when making cuts in opposite directions, makes it possible to improve the quality of mixing of the coolant flow.

Manufacturing of the cell taking into account the design diameter of the circle inscribed between the three points of the radius elements closest to the center of the cell based on the above formula allows to simplify the design, ensure manufacturability, and reduce the cost of the product with simultaneous achievement of reliable retention of the fuel elements.

### BRIEF DESCRIPTION OF DRAWINGS

The essence of the invention is explained by drawings:

FIG. 1—spacer grid of a nuclear reactor fuel assembly, general view;

FIG. 2—placement of a fuel element in a spacer grid cell, fragment;

FIG. 3—spacer grid of a nuclear reactor fuel assembly, blank of a cell field after marking;

FIG. 4—spacer grid of a nuclear reactor fuel assembly, pleated blank of a cell field,

FIG. 5—spacer grid of a nuclear reactor fuel assembly, fragment.

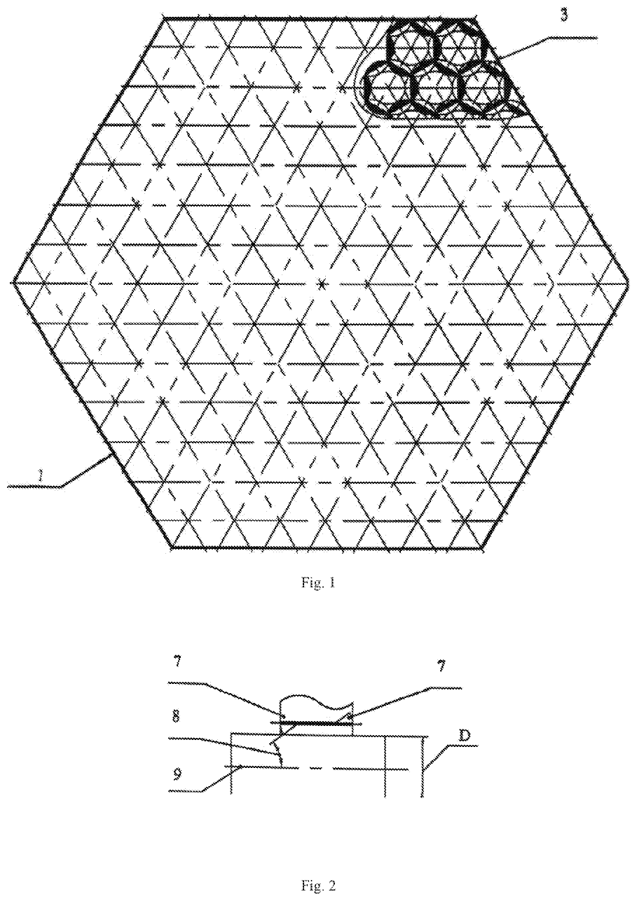

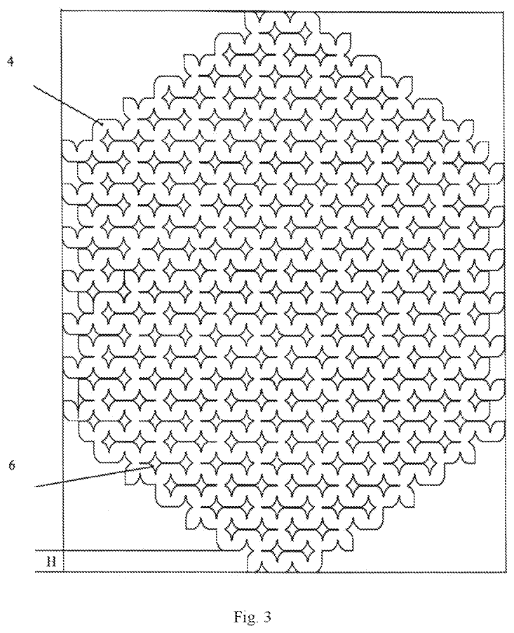

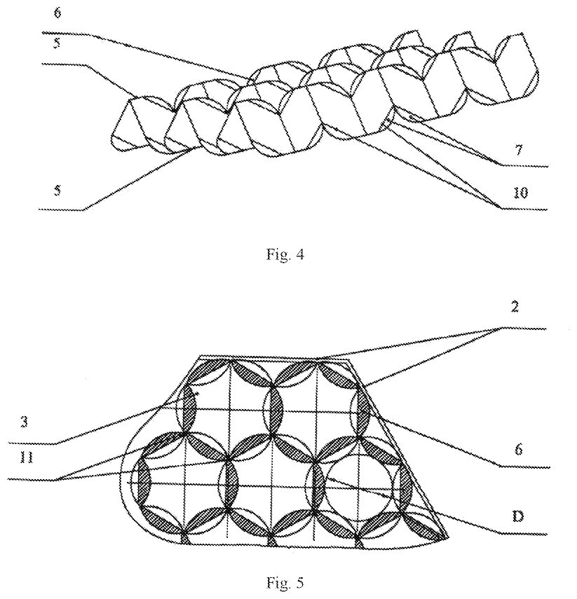

A spacer grid of a nuclear reactor fuel assembly comprises a hexagonal rim 1 with a field of hexagonal cells 3 fixed therein by spot welding 2, made from a single sheet 4, so that the folded cells 3 have bends 5 and cuts 6 for the cells 3 in one row of cells arranged on one end face of the spacer grid, and bends and cuts for the cells of the parallel row are placed on the other end face of the spacer grid, these cuts 6 for the cells 3 are made to form radius elements 7 at the ends of the cell 3, bent at an angle of 8 to the axis 9 of the cell 3 in opposite directions along bend lines 10, forming screw deflectors 11 at the ends of the cell 3.

### The Best Embodiment of the Invention

The structure is manufactured and operated as follows.

A field of hexagonal cells 3 is fabricated from a single sheet 4. To do this, the height “H” of the cells 3, cuts 6 for the cells 3 with radius elements 7 and bend lines 10 are marked on the sheet 4. According to the height marking of the cells 3, the sheet blank 4 of the future cell field 3 is pleated in its upper and lower parts, the operations of manufacturing the plate-type hexagonal cells 3 and set of the cell field 3 are combined, making cuts 6 for the pleated cells 3 in its upper and lower parts with the formation of radius elements 8, radius elements 7 are bent along lines 10 in opposite directions, the adjacent edges of adjacent cells are compressed and fixed by spot welding 2, wherein each cell 3 is formed in such a way that it has vertices at the upper and lower ends in its three corners, and depressions of screw deflectors 11 in three corners.

### Industrial Applicability

When assembling a bundle of fuel elements into a fuel assembly, each fuel element fits into the corresponding cell of the spacer grid, and is guaranteed to be reliably placed therein without displacement. At the same time, when operating a fuel assembly in a nuclear reactor, the cell design without internal protrusions, equipped with deflectors, makes it possible to achieve high-quality mixing of the coolant flow.

Thus, the use of the invention will make it possible to improve the operational characteristics of the spacer grid, namely the function of mixing the coolant flow, which affects the performance of the fuel assembly, its critical heat flux margin or the margin in terms of critical heat flux and critical power, as well as to combine the functions of mixing the flow and holding the fuel elements by single structural elements, which will simplify the design, ensure manufacturability, reduce the cost of the product and increase reliability.

What is claimed is:

1. A spacer grid of a nuclear reactor fuel assembly, comprising a hexagonal rim with a field of hexagonal cells fixed therein, made of a single sheet, so that the folded cells have bends and cuts for the cells in one row of cells arranged on one end face of the spacer grid, and bends and cuts for the cells of the parallel row are placed on the other end face of the spacer grid, wherein the cuts for the cells are designed to form radius elements at the ends of the cell, bent in opposite directions and forming screw deflectors at the ends of the cell, characterized in that the diameter of the circle inscribed between the three points of the radius elements closest to the center of the cell is calculated by the formula:
D=d·k, where
D is the diameter of the circle inscribed between the three points of the radius elements closest to the center of the cell, mm;
d is the diameter of the fuel element, mm;
k is a coefficient taking into account the springing of the bent radius element to ensure tension in the “cell—fuel element” connection.
